(19) United States
(12) Patent Application Publication
(10) Pub. No.: US 2014/0326149 A1
(43) Pub. Date: Nov. 6, 2014

(54) CROP CONTACTING ROLLER DRIVEN BY BALE FORMING BELTS

(71) Applicant: AGCO Corporation, Duluth, GA (US)

(72) Inventors: Howard Ratzlaff, Oak Harbor, WA (US); Brain Olander, Buhler, KS (US)

(73) Assignee: AGCO Corporation, Duluth, GA (US)

(21) Appl. No.: 14/365,905

(22) PCT Filed: Dec. 14, 2012
(86) PCT No.: PCT/US2012/069747

§ 371 Date: Jun. 16, 2014

Related U.S. Application Data
(60) Provisional application No. 61/570,979, filed on Dec. 15, 2011.

(51) Int. Cl. A01F 15/10; A01F 15/07

(52) U.S. Cl. CPC A01F 15/106; A01F 15/07
USPC 100/88

(57) ABSTRACT

In an example embodiment, a crop contacting roller is provided that is driven indirectly by bale forming belts of a baler. A first roller may be driven by contact with a bale forming belt and a crop contacting roller may be rotatably coupled to the first roller so that rotation of the first roller causes rotation of the crop contacting roller. The crop contacting baler may be positioned in various positions such as to contact a bale in a baling chamber of the baler or to contact incoming crop material at a throat of the baler. In one example, the crop contacting roller is rotatably coupled to a tailgate idler roll. In another example, the crop contacting roller is rotatably coupled to a bale density roll.

### FIELD OF THE INVENTION

The invention relates to round balers, and more particularly, to round baler roller elements.

### BACKGROUND

Conventional round balers receive crop material and form the crop material into bales in a baling chamber. Drive mechanisms for driving the various baler components are typically located at the front of the baler. But it may be desirable to drive a member that is not in the vicinity of existing drive mechanisms. By way of example and not limitation, it may be desirable to drive a bale formation roller that is located on the tailgate or a crop feed roller located to contact incoming crop at a throat of the baler. Running an additional drive to power components at these locations using traditional methods would be complicated and expensive, however.

### BRIEF DESCRIPTION OF THE DRAWINGS

FIG. 1 shows a side schematic view of an example embodiment of a round baler having a crop contacting roller in a tailgate section of the baler for contacting a forming bale in a baling chamber of a baler.

FIG. 2 shows a side schematic view of an example embodiment of a round baler having a crop contacting roller arranged to contact incoming crop material at a throat of the baler.

FIG. 3 shows a detailed view of the tailgate crop contacting roller of FIG. 1.

FIG. 4 shows a side schematic view of an example embodiment of a baler having a crop contacting roller at a bale density arm.

### OVERVIEW

In an example embodiment, a crop contacting roller is provided at a remote location from the forward drive mechanisms of a baler. The crop contacting roller may be driven indirectly by the bale forming belts of the baler. For example, the crop contacting roller may be powered by a roll that is powered by contact with a bale forming belt such that the crop contacting roller itself does not contact the bale forming belts. In one example embodiment, a crop contacting roller is provided at a tailgate section of a baler and driven by a tailgate idler roller. The tailgate idler roll may in turn be driven by one or more bale forming belts powered by a drive roller located on the front part of the baler. For example, bale forming belts may be driven by a drive roller and the belts arranged to engage the outer surface of a tailgate idler roller so as to rotate the tailgate idler roller. The idler roller may in turn be used to rotate a crop contacting roller. For example, a shaft may extend outward from the tailgate idler roll to which a sprocket-chain, sheave-belt, gear drive mechanism, or similar arrangement is attached. That sprocket-chain arrangement drive mechanism may then be used to turn the crop contacting roller which may have a related sprocket. In this arrangement, the crop contacting roller is not connected to the drives at the front of the baler and has no direct contact with the forming belts, but nevertheless can be powered indirectly by the tailgate idler roll. This allows the crop contacting roller to be provided at a variety of remote locations. For example, the crop contacting roller may be provided at the tailgate to contact a bale forming in the baling chamber or to contact crop material moving through a throat of the baler, or at some other location that is remote from the baler drive means.

In one example embodiment, a tailgate crop contacting roller is located on the front bottom corner of the tailgate, in front of a front bottom forming belt idler roll. The bottom forming belt idler roll has a shaft extending out of the side on the axis of the roller. A sprocket is attached to the shaft. The crop contacting roller may be provided with a similar shaft and sprocket. A chain may be wrapped around the two sprockets to movably couple the two rollers.

Power may be provided by a power takeoff shaft (PTO) of a tractor or other vehicle that is mechanically coupled to a gearbox, which may power a belt drive roll. For example, the gearbox of the baler may be driven by the PTO and mechanically connected to one or more belt drive rolls by a chain or the like. The forming belt drive roll may power the bale forming belts which turn a lower front forming belt idler roll. The lower front forming belt idler roll may turn the tailgate crop contacting roller using the mechanism discussed above. Thus, a crop contacting roller may be provided in a tailgate or other remote section of the baler and powered by the use of the bale forming belts without the need of additional drives located at the tailgate or near the crop contacting roll.

In another example embodiment, a crop contacting roller may be positioned to contact crop entering the throat of the baler. The crop contacting roller may thereby assist in feeding crop material to the bale forming chamber. In another example embodiment, the crop contacting roller may be located on a bale density arm and powered by a bale density roller provided on a bale density arm.

### DETAILED DESCRIPTION

As required, example embodiments of the present invention are disclosed herein. The various embodiments are meant to be non-limiting examples of various ways of implementing the invention and it will be understood that the invention may be embodied in alternative forms. The present invention will be described more fully hereinafter with reference to the accompanying drawings in which like numerals represent like elements throughout the several figures, and in which example embodiments are shown. The figures are not necessarily to scale and some features may be exaggerated or minimized to show details of particular elements, while related elements may have been eliminated to prevent obscuring novel aspects. The specific structural and functional details disclosed herein should not be interpreted as limiting, but merely as a basis for the claims and as a representative basis for teaching one skilled in the art to variously employ the present invention.

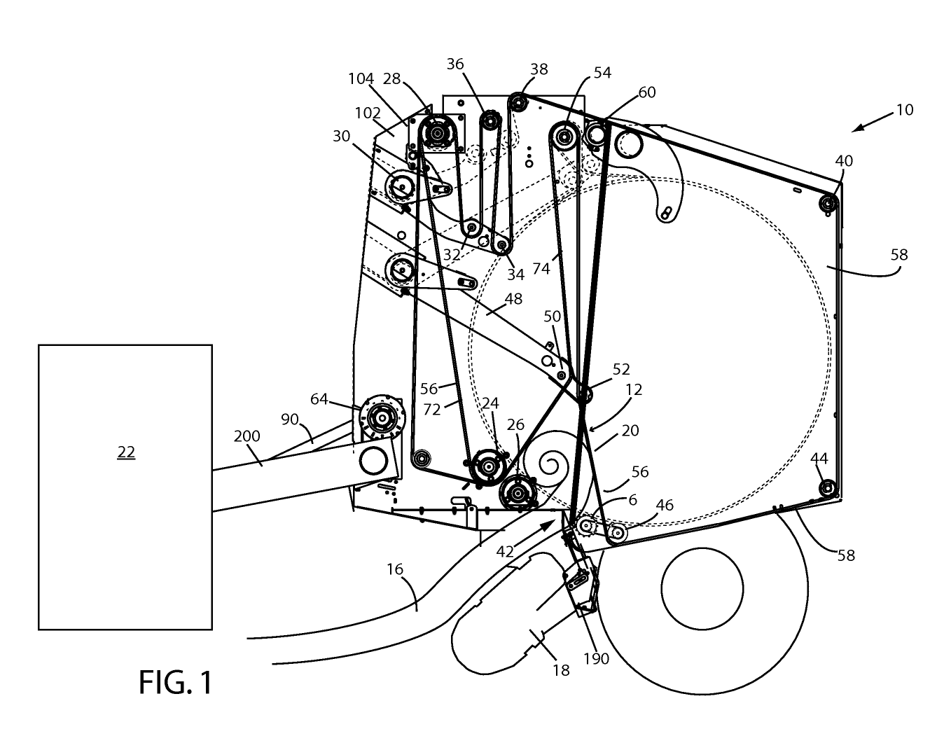

Turning to the figures, FIG. 1 shows an example embodiment of a round baler 10 having bale forming belts 56 for forming a bale 20 in a baling chamber 12. A vehicle, such as a tractor 22 may be used to power the baler 10 and pull it through the field. A pickup assembly 18 may gather crop material 16 from the ground and feed it into a throat 42 of the baling chamber 12. A crop contacting roller 6 may be provided at the tailgate 58 of the baler 10.

The baler 10 may be generally similar to the balers produced by AGCO Corporation, such as those disclosed in U.S. Pat. Nos. 7,337,713; 6,477,824; 6,675,561; 4,850,271; and 4,524,867, all of which are assigned to the Applicant of the present invention and incorporated by reference in their entirety herein. The baling chamber 12 of the baler 10 may comprise a number of rolls and belts that cooperate to assume different shapes and sizes throughout a bale-forming cycle. In this respect, the example round baler 10 may be referred to as a “variable chamber” belt type machine, wherein the baling chamber 12 is initially small, and then grows progressively larger as the bale 20 increases in diameter within the baler 10 (shown in dashed lines).

With the foregoing general explanation in mind, in the example embodiments shown, a bale forming chamber 12 includes a lower drive roll 24 and a starter roll 26. Above the lower drive roll 24 is an upper drive roll 28. Pivotally mounted within the baler is a belt tension arm 30 to which are pivotally mounted the front belt tension roll 32 and a rear belt tension roll 34. At the top of the front portion of the baling chamber are a front upper idler roll 36 and a rear upper idler roll 38. Following the interior of the baler wall around clockwise, there is a tailgate belt roll 40, a lower rear tailgate roll 44, and front lower idler roll 46. A bale density arm 48 is pivotally mounted within the baler and has a front bale density roll 50 and a rear bale density roll 52, both pivotally mounted on the distal end from the pivotal mounting of the bale density arm 48. Near the top of the baling chamber above the bale density rolls is depicted an upper baling chamber roll 54. A plurality of bale forming belts 56 (one shown in profile) are threaded around each of the above identified rolls. The bale forming belts 56 are tensioned by the front and rear belt tension rolls 32, 34, mounted on the belt tension arm 30 and the rolls 50, 52 mounted on the bale density arm 48.

The baling chamber 12 is open at the bottom to provide a chamber inlet or throat 42 defined generally between the starter roll 26 and the idler roll 46. The baling chamber 12 may be located above and off the ground and a means provided for picking up crop material 16 and delivering the picked-up material into the baling chamber 12. In the example embodiment, a pickup header 18 having a standard resilient rotary rake tine assembly for picking crop material 16 up off the ground may be used.

Windrowed crop material 16 may be fed into the baler 10 by the pickup assembly 18 and moved to the chamber inlet 42 and fed into the bottom of the open throat 42 baling chamber 12. When in the baling chamber 12, the crop material 16 contacts the surface of a belt stretch which is moving upward. The forming belts 56 may be driven by the upper 28 and lower 24 drive rolls so that the forming belts 56 carry the crop material 16 to the top of the baling chamber 12 and the motion of the forming belts 56 turns the crop material 10 downward against the starter roll 26 so that a bale core is started and begins to roll. The crop material 16 may be initially formed into a small bale 20 within the baling chamber 12 and the process continued to form an enlarged bale of a desired size. Although not illustrated in detail, it will be appreciated by one of ordinary skill in the art that the baling chamber 12 may initially assume a generally vertical, triangular configuration when the baling chamber 12 is empty and enlarge as the bale 20 grows in size (shown in dashed lines). The baler includes a tailgate 58 that opens and closes around pivot point 60. A kicker assembly (not shown) may be used to eject a fully formed bale through the open tailgate.

Power for operating the components of the baler 10 may be delivered by a drive line 90 associated with a tongue 200 of the baler. A front end of such a drive line can be adapted for connection to the power take-off shaft (not shown) of the towing vehicle, while the rear end of the driveline can be coupled with various drives, pumps, and/or other components for the driving the various baler components. In the example embodiment, shown in FIG. 1, the PTO may be coupled to a gear arrangement 64 to power various components such as the bale forming belts 56.

For example, the bale forming belts 56 may be driven by the lower 24 and upper 28 drive rolls whose rotation results in movement of the bale forming belts 56. The drive rolls 24, 28 may in turn be powered mechanically by the gear box 64. Alternatively, the drive rolls 24, 28 could be powered by hydraulic means as known in the art.

Once in baling chamber 12, the crop material 16 contacts the rough top surface of forming belts 56 which are moving upward. The forming belts 56 carry the crop material 16 to the top of the starting chamber which is formed by the front and rear bale density rolls 50, 52. The motion of the forming belts 56 turns the crop material downward against starter roll 26. The core is started and begins to roll. Hydraulic cylinders pull down on the bale density arm 48 and belt tension 30 arms. The bale density rolls 50, 52 are held down to reduce the size of the baling chamber to a starting size. The belt tension rolls 32, 34 are held down to supply tension to the forming belts. As the bale increases in size, the bale density rolls 50, 52 and the belt tension rolls 32, 34 are forced upward. The bale density rolls 50, 52 put an increasing amount of downward force against the bale. This force keeps tension on the bale and compresses the crop material coming into the baling chamber. The belt tension rolls move upward to provide more forming belt for the increased size of the bale within the chamber. As the bale size increases and bale density arm 48 moves upward. When the bale reaches a full size, it may be wrapped, the tailgate 58 opening, and the bale ejected.

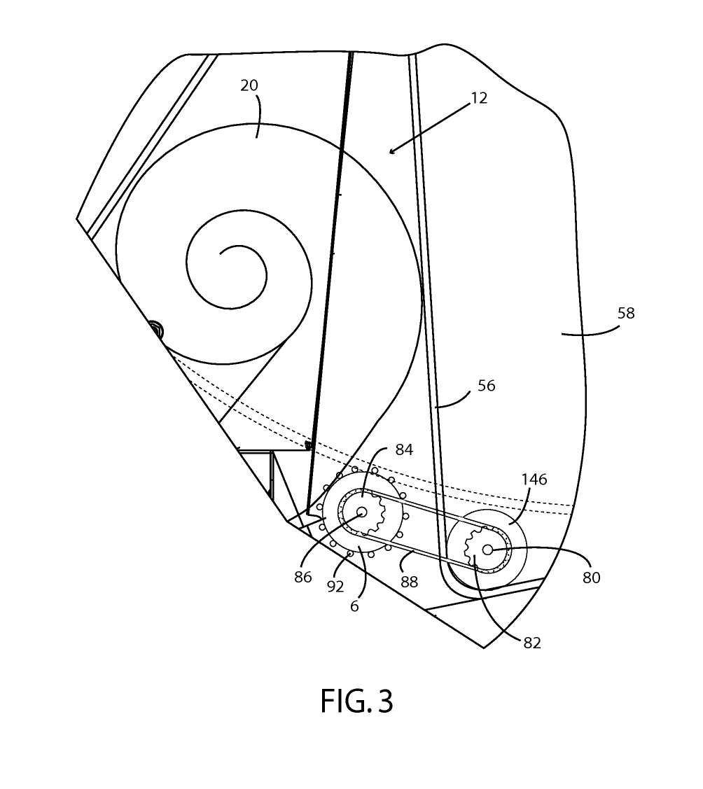

In an example embodiment, a crop contacting roller 6 is provided at a tailgate section and driven indirectly by bale the bale forming belts 56 by the tailgate idler roll 46. The tailgate idler roll 46 may be provided at the tailgate 58 and driven via contact with the bale forming belts 56. A shaft 80 may be provided on the tailgate idler roller 46 to which a sprocket 82 is attached. The sprocket 82 may be coupled to a sprocket 84 on a shaft 86 of the crop contacting roller 6 by a chain 88 so that the idler roll 46 turns the crop contacting roller 6. In this arrangement the crop contacting roll 6 has no contact with the forming belts 56, but may still be used to influence crop material 16 inside the baler 10. For example, the crop contacting roll 6 may be provided forward of the lower idler roll 46 and slightly rearward of the inlet 42. In the example embodiment shown in FIGS. 1 and 3, the crop contacting roll 6 may be a positioned to contact a bale 20 forming in the baling chamber 12 and/or crop material 16 entering the throat 42. The crop contacting roll 6 may be provided with crop engaging elements 92. The crop contacting roller is located on the front bottom corner of the tailgate 58, in front of the front bottom forming belt idler roll 46.

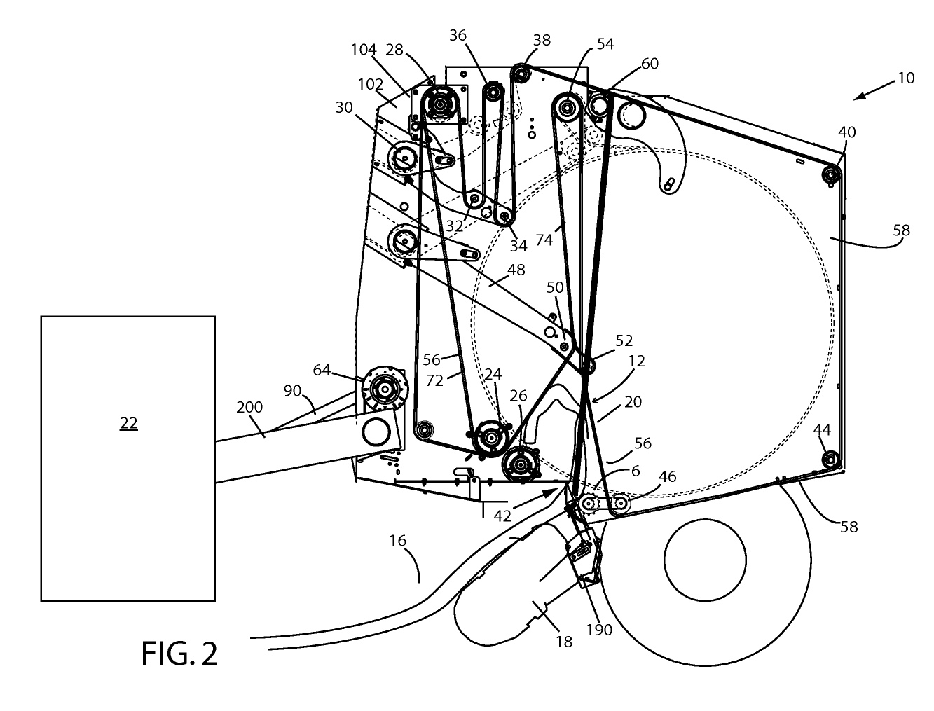

FIG. 2 shows an example embodiment similar to that of FIG. 1 in which the crop contacting roller 6 contacts crop material entering the throat 42 and assists in the feeding or funneling the crop material 16 to the bale. In this example embodiment, the crop contacting roller 6 does not contact a formed bale in the baling chamber.

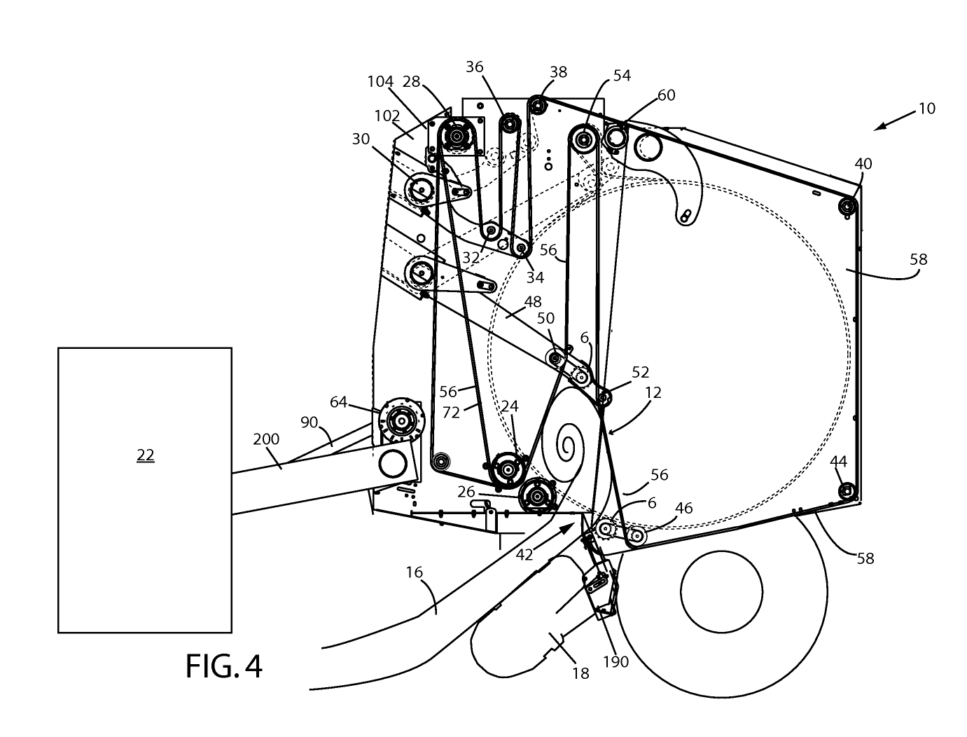

While in the example embodiments discussed above the crop contacting roller 6 was powered by the lower tailgate idler roll 46 and located forward of the idler roll 46 and rearward of the inlet 42, a crop contacting roll 6 may be powered by other components and located in other positions about the baler. For example, in the example embodiment shown in FIG. 4, a crop contacting roll 6 may also be positioned on a bale density arm 48 and powered by a bale density roll 50. The bale density roll 50 may be rotated through contact with the bale forming belts 56 and coupled to the crop contacting roll 6 by the chain 88. Furthermore, other rollers could be powered by the bale forming belts in addition to or in lieu of the use of the lower idler roll 46. Thus, a crop contacting roller may be provided in a tailgate or other remote portion of the baler and powered by the bale forming belts without the need of additional drives located at the tailgate or proximate to the crop contacting roller.

What is claimed is:

1. An apparatus, comprising:
a round baler;
a first roller powered by contact with a bale forming belt of the round baler; and
a crop contacting roller rotatably coupled to the first roller.

2. The apparatus of claim 1, wherein a sprocket of the first roller is coupled with a sprocket of the crop contacting roller.

3. The apparatus of claim 1, wherein the first roller is located in a tailgate section of the round baler.

4. The apparatus of claim 3, wherein the crop contacting roller is located in a tailgate section of the round baler.

5. The apparatus of claim 1, further comprising:
a movable tailgate, wherein the first roller and the crop contacting roller are coupled to the movable tailgate of the round baler.

6. The apparatus of claim 1, wherein the crop contacting roller is positioned rearward of a throat of the baler.

7. The apparatus of claim 1, wherein the crop contacting roller is positioned to contact a bale forming in a baling chamber of the baler.

8. The apparatus of claim 1, wherein the crop contacting roller is positioned to contact incoming crop material at a throat of the baler.

9. The apparatus of claim 1, wherein the crop contacting roller is mounted to a bale density arm.

10. The round baler of claim 1, wherein the first roller comprises a bale density roll.

11. The apparatus of claim 1, wherein the crop contacting roller has a crop contacting element.

12. The apparatus of claim 1, wherein the first roller is a forward bale forming idler roll.

13. An apparatus, comprising:
a first roller configured to be rotated by contact with a bale forming belt of a round baler; and
a crop contacting roller configured to be driven by the first roller.

14. The apparatus of claim 13, wherein the crop contacting roller is rotatably coupled to the first roller by a sprocket chain arrangement.

15. A roller apparatus, comprising:
a rotatable element configured to be driven for rotation by a bale forming belt of a round baler;
a crop contacting roller configured to contact crop material in the baler; and
a mechanism for driving the crop contacting roller by the rotatable element.

16. The apparatus of claim 15, wherein the mechanism is a sprocket and chain arrangement.

17. The round baler of claim 15, wherein the rotatable element is a tailgate idler roll.

18. The round baler of claim 15, wherein the rotatable element is a bale density roll.

19. The round baler of claim 15, wherein the crop contacting roller is configured to contact a bale in a bale forming chamber of the baler.

20. The round baler of claim 15, wherein the crop contacting roller is configured to contact crop incoming at a throat of the round baler.
